(19) United States
(12) Patent Application Publication
(10) Pub. No.: US 2012/0191952 A1
(43) Pub. Date: Jul. 26, 2012

(54) PROCESSOR IMPLEMENTING SCALAR CODE OPTIMIZATION

(75) Inventors: Jay E. FLEISCHMAN, Ft. Collins, CO (US); Matthew M. CRUM, Austin, TX (US); Kelvin GOVEAS, Austin, TX (US); Michael D. ESTLICK, Ft. Collins, CO (US); Barry J. ARNOLD, Ft. Collins, CO (US); Ranganathan SUDHAKAR, Santa Clara, CA (US); Betty A. MCDANIEL, Austin, TX (US)

(73) Assignee: ADVANCED MICRO DEVICES, INC., Sunnyvale, CA (US)

(21) Appl. No.: 13/011,637

(22) Filed: Jan. 21, 2011

(51) Int. Cl. G06F 9/318; G06F 9/30

(52) U.S. Cl. 712/216; 712/229; 712/E09.028; 712/E09.035

(57) ABSTRACT

Methods and apparatuses are provided for increased efficiency and enhanced power saving in a processor via scalar code optimization. The method comprises determining that an instruction comprises a scalar instruction and then processing the instruction using only a lower portion of an XMM register. The apparatus comprises an operational unit capable of determining whether an instruction comprises a scalar instruction and execution units responsive that determining for processing the scalar instruction using only a lower portion of an XMM register of the processor. By not processing the upper portion of the XMM register efficiency is increased and power saving is enhanced.

### TECHNICAL FIELD

The subject matter presented here relates to the field of information or data processor architecture. More specifically, this invention relates to scalar code optimization.

### BACKGROUND

Information or data processors are found in many contemporary electronic devices such as, for example, personal computers, personal digital assistants, game playing devices, video equipment and cellular phones. Processors used in today's most popular products are known as hardware as they comprise one or more integrated circuits. Processors execute software to implement various functions in any processor based device. Generally, software is written in a form known as source code that is compiled (by a complier) into object code. Object code within a processor is implemented to achieve a defined set of assembly language instructions that are executed by the processor using the processor's instruction set. An instruction set defines instructions that a processor can execute. Instructions include arithmetic instructions (e.g., add and subtract), logic instructions (e.g., AND, OR, and NOT instructions), and data instructions (e.g., move, input, output, load, and store instructions). As is known, computers with different architectures can share a common instruction set. For example, processors from different manufacturers may implement nearly identical versions of an instruction set (e.g., an x86 instruction set), but have substantially different architectural designs.

SSE (Streaming Single-Instruction-Multiple-Data Extensions) and AVX (Advanced Vector Extensions) are extensions of the x86 instruction sets. Scalar code (instructions) executed in SSE or AVX require merging of a portion of the XMM register, which can produce dependencies between operations that can greatly reduce performance. Generally, the upper portion of the XMM register in scalar code (instructions) will be logical zero. Thus, for double-precision scalar data, bits 64 through 127 are often zero, while bits 32 through 127 are often zero for single-precision scalar data. Since the scalar operations are defined such that the value in the upper portion remain unchanged and are simply passed through, dependencies causing scalar instructions to wait for processing of the upper portion of scalar data during execution of the scalar instructions are wasteful of power and operational cycles of the processor. Such dependencies are known as false dependencies and should be eliminated whenever possible.

### BRIEF SUMMARY OF THE EMBODIMENTS

An apparatus is provided for increased efficiency and enhanced power saving in a processor via scalar code optimization. The apparatus comprises an operational unit capable of determining whether an instruction comprises a scalar instruction and execution units responsive that determining for processing the scalar instruction using only a lower portion of an XMM register of the processor. By not processing the upper portion of the XMM register efficiency is increased and power saving is enhanced.

A method is provided for increased efficiency and enhanced power saving in a processor via scalar code optimization. The method comprises determining that an instruction comprises a scalar instruction and then processing the instruction using only a lower portion of an XMM register. By not processing the upper portion of the XMM register efficiency is increased and power saving is enhanced.

### BRIEF DESCRIPTION OF THE DRAWINGS

Embodiments of the present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of floating-point unit or integer unit suitable for use with the processor of FIG. 1;

FIGS. 3A and 3B are exemplary illustrations of an XMM register suitable for use in the processor of FIG. 1;

FIG. 4 is an exemplary block diagram of a logical-to-physical register remapping table suitable for use in the processor of FIG. 1; and

FIG. 5 is an exemplary flow diagram illustrating a method according to one embodiment of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

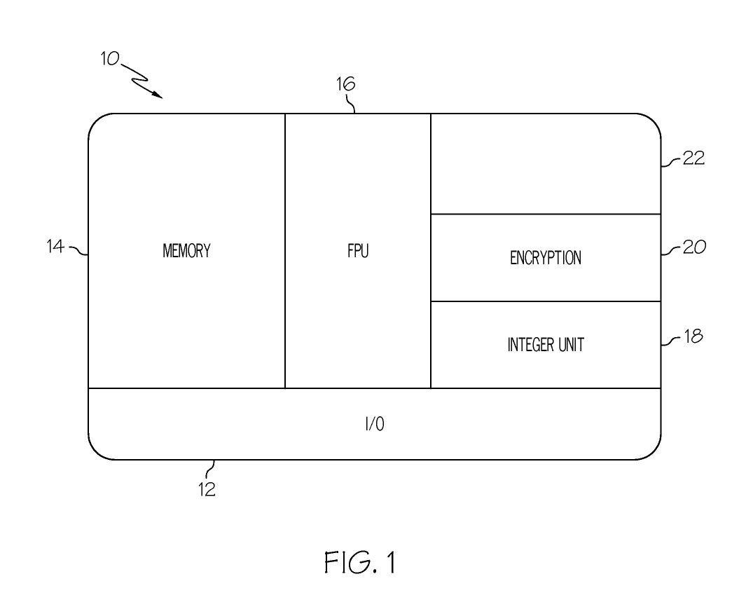

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Within a processor, numerical data is typically expressed using integer or floating-point representation. Mathematical computations within a processor are generally performed in computational units designed for maximum efficiency for each computation. Thus, it is common for processor architecture to have an integer computational unit and a floating-point computational unit. Additionally, an encryption unit 20 and various other types of units (generally 22) as desired for any particular processor microarchitecture may be included.

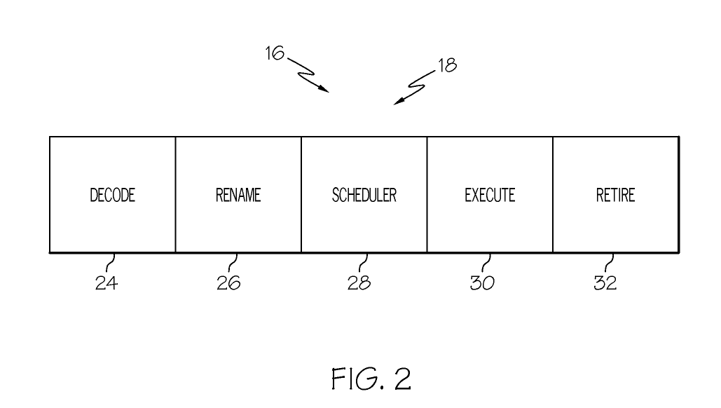

Referring now to FIG. 2, a simplified exemplary block diagram of an operational unit suitable for use with the processor 10. In one embodiment, FIG. 2 could operate as the floating-point unit 16, while in other embodiments FIG. 2 could illustrate the integer unit 18.

In operation, the decode unit 24 decodes the incoming operation-codes (opcodes) dispatched (or fetched by) a computational unit. The decode unit 24 is responsible for the general decoding of instructions (e.g., x86 instructions and extensions thereof) and how the delivered opcodes may change from the instruction. The decode unit 24 will also pass on physical register numbers (PRNs) from an available list of PRNs (often referred to as the Free List (FL)) to the rename unit 26.

The rename unit 26 maps logical register numbers (LRNs) to the physical register numbers (PRNs) prior to scheduling and execution. According to various embodiments of the present disclosure, the rename unit 26 can be utilized to rename or remap logical registers in a manner that eliminates the need to actually store known data values in a physical register. This saves operational cycles and power, as well as decrease latency.

The scheduler 28 contains a scheduler queue and associated issue logic. As its name implies, the scheduler 28 is responsible for determining which opcodes are passed to execution units and in what order. In one embodiment, the scheduler 28 accepts renamed opcodes from rename unit 26 and stores them in the scheduler 28 until they are eligible to be selected by the scheduler to issue to one of the execution pipes.

The execute unit(s) 30 may be embodied as any general purpose or specialized execution architecture as desired for a particular processor. In one embodiment the execution unit may be realized as a single instruction multiple data (SIMD) arithmetic logic unit (ALU). In other embodiments, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 32 maintains an in-order list of all opcodes in process in the floating-point unit 16 (or integer unit 18 as the case may be) that have passed the rename 26 stage and have not yet been committed by to the architectural state. The retire unit 32 is responsible for committing all the floating-point unit 16 or integer unit 18 architectural states upon retirement of an opcode.

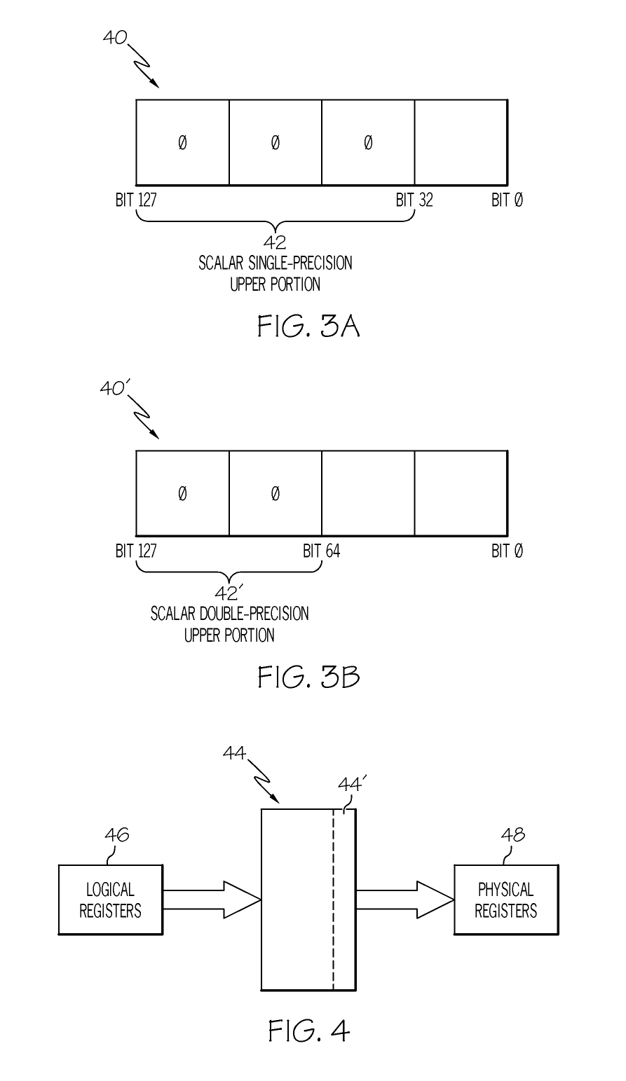

Referring now to FIG. 3A, an illustration of a scalar single-precision XMM register 40 is shown. As can be seen, the XMM register 40 has a length of 128 bits (bit 0 through bit 127). As noted above, the upper portion of the XMM register in scalar code (instructions) will often be logical zero. Accordingly, as illustrated in FIG. 3A, all of the bits in the upper portion 42 (bit 32 through bit 127) of the XMM register 40 will have a logic zero value, while the lower portion (bit 0 through bit 31) will contain the single-precision data. Therefore, false dependencies caused by scalar instructions waiting for processing of the upper portion of scalar data during execution of the scalar instructions are wasteful of power and operational cycles of the processor since any scalar operation will result in simply merging in the zero value. According to the embodiment of the present disclosure, false dependencies (waiting) to complete the scalar instruction can be avoided by not processing the known-zero upper portion 42 of the XMM register 40. After the lower portion of the XMM register has been processed, the instruction can be considered completed and the scalar instruction retired earlier than if the operation has waited for the processing of the zero valued upper potion 42. In this way, the embodiments of the present disclosure break the false dependency of waiting for a zero result. For scalar instruction not having the potential to produce false dependencies, power savings enhancement is still achieved by not processing the upper portion (upper zeros) of the scalar instruction.

In a similar manner, FIG. 3B illustrates a scalar double-precision XMM register 40′. In the case of scalar double-precision data, all of the bits in the upper portion 42′ (bit 64 through bit 127) of the XMM register 40′ will have a logic zero value, while the lower portion (bit 0 through bit 63) will contain the double-precision data. At execution time, only the lower portion of the XMM register 42′ need be processed and the execution units that would have processed the upper potion (upper zeros) 42′ of the XMM register 40′ can remain idle and conserve power.

As an example, and not as a limitation, the following table lists some of the scalar instructions in x86 SSE and AVX128 instruction sets that potentially may cause dependencies and can benefit from breaking those false dependencies due to the merged ‘upper’ data.

| | |
|---|---|
| CVTPI2PS | Convert Packed-Integer to Packed Single Precision |
| CVTSD2SS | Convert Scalar Double to Scalar Single Precision |
| CVTSI2SD 32 | Convert Signed 32b Integer to Scalar Double Precision |
| CVTSI2SS 32 | Convert Signed 32b Integer to Scalar Single Precision |
| CVTSI2SD 64 | Convert Signed 64b Integer to Scalar Double Precision |
| CVTSI2SS 64 | Convert Signed 64b Integer to Scalar Single Precision |
| CVTSS2SD | Convert Scalar Single to Scalar Double Precision |
| MOVSS | Move Scalar Single-Precision |
| MOVSD | Move Scalar Double-Precision |
| MOVLPD | Move Lower Packed Double-Precision |
| MOVLPS | Move Lower Packed Single-Precision |
| RCPSS | Reciprocal Scalar Single Precision |
| FRCZSD | Extract Fraction Scalar Double Precision |
| FRCZSS | Extract Fraction Scalar Single Precision |
| ROUNDSD | Round Scalar Double-Precision |
| ROUNDSS | Round Scalar Single-Precision |
| RSQRTSS | Reciprocal Square Root Scalar Single Precision |
| SQRTSD | Square Root Scalar Double-Precision |
| SQRTSS | Square Root Scalar Single-Precision |

Many, other scalar instructions can benefit by the power savings enhancement of the present disclosure, even if those scalar instructions do not cause false dependencies. That is, while a scalar instruction may not cause a dependency, it may still produce a logic-zero value for the upper portion of the XMM register. Accordingly, not processing the known-zero upper portion value for those instructions provide power savings enhancement even if there are no false dependencies to eliminate. As an example, and not as a limitation, the x86 instruction set contains approximately 100 scalar instructions that could benefit from the power saving enhancement of the present disclosure.

Referring now to FIG. 4, a logical-to-physical remapping table 44, which in one embodiment of the present disclosure resides in the rename unit 26 (see FIG. 2) is depicted. As is known in contemporary processor design, it is common to have several architected or logical registers 46 that are mapped to a number of physical registers 48. This allows the physical registers to store data for the duration of an instruction (or multiple instructions) while the logical registers can be made available (re-mapped) on a continuous basis during instruction processing. According to one embodiment of the disclosure, the logical-to-physical remapping table 44 is augmented with a zero-bit (Z-bit) field 44′. For some instructions, the Z-bit field for any particular mapping can be set or cleared directly. For other instructions, the new Z-bit field is a function of the Z-bit fields of the instruction's sources and destination operands. The new value for the Z-bit field is written at the time of mapping a logical register 46 to a physical register 48, and remains valid until re-mapping of the logical register. At execution time, the data from the Z-bit field 44′ (potentially stored in the Scheduler 28 in FIG. 2) can be used as an indicator that the upper portion (42 or 42′, see FIGS. 3A and 3B) need not be processed as they are known to have a logic zero In this way, processor efficiency is increased and power saving is enhanced by not processing the known-zero value upper portion of the XMM register for scalar instructions.

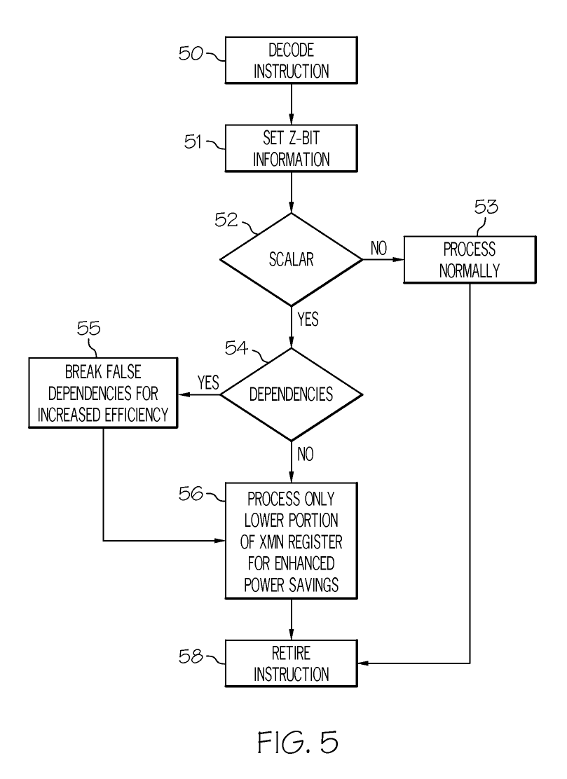

Referring now to FIG. 5, a flow diagram illustrating the method of the embodiments of the present disclosure is shown. The various tasks performed in connection with the process of FIG. 5 may be performed by software, hardware, firmware, or any combination thereof. For illustrative purposes, the following description of the process of FIG. 4 may refer to elements mentioned above in connection with FIGS. 1-4. In practice, portions of the process of FIG. 5 may be performed by different elements of the described system. It should also be appreciated that the process of FIG. 5 may include any number of additional or alternative tasks and that the process of FIG. 5 may be incorporated into a more comprehensive procedure or process having additional functionality not described in detail herein. Moreover, one or more of the tasks shown in FIG. 5 could be omitted from an embodiment of the process of FIG. 5 as long as the intended overall functionality remains intact.

Beginning in step 50, an instruction is decoded. Based on the decoded instruction, the Z-bit value is determined as a function of the instruction and the Z-bit values of its source and destination operands. Using this information, the Z-bit information is set in step 51. Next, decision 52 determines if the instruction is a scalar instruction (single-precision or double-precision). If so, decision 54 determines whether the particular scalar instruction has false dependencies that can be removed. If so, step 55 breaks (eliminates) those false dependencies by not waiting for the merged data source for the upper (zero) data portion of the XMM register. Following this, and also in the event that the determination of decision 54 is that there are no dependencies to be eliminated, the instruction is processed using only the lower portion of the XMM register (step 56), which affords the power saving enhancement of the present disclosure. When the scalar instruction is completed, it can be retired 58 (see 32 of FIG. 2) and registers in use during the processing of the scalar instruction can be made available for use by later instructions. If however, the determination of decision 52 is that the decoded instruction is not a scalar instruction, then the instruction is process normally (step 53) and retired at the completion of the instruction (step 58).

Various processor-based devices that may advantageously use the processor (or any computational unit) of the present disclosure include, but are not limited to, laptop computers, digital books or readers, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or any computational) unit of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
determining that an instruction comprises a scalar instruction; and
processing the instruction using only a lower portion of an XMM register of a processor.

2. The method of claim 1, wherein determining that the instruction comprises the scalar instruction further comprises determining that the instruction comprises a single-precision scalar instruction.

3. The method of claim 2, wherein determining that the instruction comprises a single-precision scalar instruction comprises determining that the single-precision scalar instruction is one of a group of single-precision scalar instructions identified as potentially producing false dependencies.

4. The method of claim 1, further comprising not processing an upper portion of the XMM register thereby saving power in at least one execution unit.

5. The method of claim 1, wherein determining that the instruction comprises the scalar instruction further comprises determining that the instruction comprises a double-precision scalar instruction

6. The method of claim 5, wherein determining that the instruction comprises a double-precision scalar instruction comprises determining that the double-precision scalar instruction is one of a group of double-precision scalar instructions potentially producing false dependencies.

7. The method of claim 1, further comprising setting an indication that the instruction comprises the scalar instruction responsive to determining that the instruction comprises the scalar instruction.

8. A method, comprising:
determining that an instruction comprises a scalar instruction; and
breaking false dependencies during execution of the scalar instruction via processing only a portion of an XMM register storing an operand of the scalar instruction.

9. The method of claim 8, wherein breaking false dependencies during execution of the scalar instruction via processing only a portion of the XMM register further comprises processing only non-logic zero portions of the XMM register.

10. The method of claim 8, further comprising not processing an upper portion of the XMM register thereby saving power in at least one execution unit.

11. The method of claim 8, wherein determining that an instruction comprises a scalar instruction further determining that the instruction comprises one of a group of scalar instructions potentially producing false dependencies.

12. A processor, comprising:
execution units for processing a scalar instruction using only a lower portion of an XMM register of the processor responsive to a determination that the instruction comprises a scalar instruction.

13. The processor of claim 12, further comprising a unit having an indication whether the instruction comprises the scalar instruction.

14. The processor of claim 13, wherein the execution units process only a non-logic zero portion of the XMM register when the indication indicates a scalar instruction.

15. The processor of claim 13, wherein the execution units process all bits of the XMM register responsive to a determination that the instruction does not comprise a scalar instruction.

16. A device comprising the processor of claim 12, the device comprising at least one of a group consisting of: a computer; a digital book; a printer; a scanner; a television; a mobile telephony device; or a set-top box.

17. A processor, comprising:
execution units for processing a scalar instruction using only a lower portion of an XMM register of the processor responsive to a determination that the scalar instruction potentially produces the false dependency;
wherein, the false dependency is eliminated.

18. The processor of claim 17, wherein the execution units process only a non-logic zero portion of the XMM register when the indication indicates the scalar instruction potentially produces the false dependency.

19. The processor of claim 18, wherein the execution units process all bits of the XMM register when the indication indicates a non-scalar instruction.

20. A device comprising the processor of claim 17, the device comprising at least one of a group consisting of: a computer; a digital book; a printer; a scanner; a television; a mobile telephony device; or a set-top box.
